(19) United States
(12) Patent Application Publication
(10) Pub. No.: US 2004/0119683 A1
(43) Pub. Date: Jun. 24, 2004

(54) Vehicular secondary control interface system

(76) Inventors: David Robert Warn, Royal Oak, MI (US); Donald James Mc Millan, Troy, MI (US); Charles Weldon Wampler II, Birmingham, MI (US); Donn W. Glander, Grosse Pointe Woods, MI (US)

Correspondence Address: KATHRYN A MARRA, General Motors Corporation, Legal Staff, Mail Code 482-C23-B21, P.O. Box 300, Detroit, MI, 48265-3000, US

(21) Appl. No.: 10/324,587

(22) Filed: Dec. 19, 2002

(51) Int. Cl. G09G 5/00

(52) U.S. Cl. 345/156

(57) ABSTRACT

A vehicular secondary control interface is disclosed. In an exemplary embodiment, the control interface includes a plurality of category input devices for selecting a function category, with each of the function categories having one or more selectable secondary functions associated therewith. A display area displays the selectable secondary functions associated with a selected function category, highlighting the active secondary function, and further displays parameter information regarding the active secondary functions. In addition, a selection input device adjustably selects the secondary functions associated with a selected function category, and an adjustment input device controls the active secondary function associated with the selected function category.

### BACKGROUND

The present disclosure relates generally to vehicular secondary control devices and, more particularly, to a reconfigurable, haptic interface system for use with vehicle secondary controls.

Modern automobiles continue to become increasingly equipped with various secondary features such as advanced climate control systems, vehicular information systems, audio systems, video systems, navigation systems, communication/internet systems, and the like. With this increased functional capability and convenience provided to drivers and passengers alike, there is also an associated increase in the amount of control knobs, levers and switches provided within the vehicle dashboards, steering wheels and rear seat areas. In fact, the complexity of certain modern vehicle cockpits is not at all dissimilar to that of an actual aircraft cockpit.

Unfortunately, with the increasing number of applications and associated controls included within a vehicle, there is also the reality of the increased amount of effort a driver expends in locating and actuating the specific control corresponding to the desired function. In order to address this problem, reconfigurable haptic devices have been proposed to perform multiple functions, thereby resulting in a reduced total number of knobs, switches and other controls included in a vehicle. However, such proposals have typically tended to over-integrate various control functions within a single knob/switch. For example, a knob that provides both a selection function and an adjustment function may present some difficulty for a driver with respect to determining which of the two features (i.e., selection or adjustment) is being controlled. As such, an opposite intended effect (e.g., increased effort) might result.

Accordingly, it is desirable to be able to simplify a vehicle control panel, both in terms of the overall amount of knobs and switches included therein, as well as in terms of the ease of use of the controls themselves.

### SUMMARY

In an exemplary embodiment, a vehicular secondary control interface includes a plurality of category input devices for selecting a function category, with each of the function categories having one or more selectable secondary functions associated therewith. A display area displays the selectable secondary functions associated with a selected function category, highlighting the active secondary function, and further displays parameter information regarding the active secondary functions. In addition, a selection input device adjustably selects the secondary functions associated with a selected function category, and an adjustment input device controls the active secondary function associated with the selected function category.

In another aspect, a vehicular secondary control interface system includes an interface control computer in communication with a plurality of vehicle secondary devices and a vehicle control panel. The vehicle control panel further includes a plurality of category buttons for selecting a function category, with each of the function categories having one or more selectable secondary functions associated therewith. A display area displays the selectable secondary functions associated with a selected function category, highlighting the active secondary function, and further displays parameter information regarding the active secondary functions. In addition, a select knob adjustably selects the secondary functions associated with a selected function category, and an adjust knob controls the active secondary function associated with the selected function category.

### BRIEF DESCRIPTION OF THE DRAWINGS

Referring to the exemplary drawings wherein like elements are numbered alike in the several Figures:

FIG. 1 is a block diagram of a vehicular secondary control interface system, in accordance with an embodiment of the invention;

FIG. 2 is a schematic diagram of an exemplary layout of a control panel and associated display of the control interface system;

FIG. 3 is a schematic diagram of an alternative embodiment of the control panel and display, configured to resemble a 1950's era pushbutton radio;

FIG. 4 is a schematic diagram of still another alternative embodiment of the control panel and display, configured within a vehicle steering wheel;

FIG. 5 is an exemplary view of the control panel after the “sound” category button has been pushed;

FIG. 6 is an exemplary status screen displayed following certain period of time after the select and adjust functions have been activated, or after the status button has been pressed;

FIGS. 7(a) through 7(h) illustrate the top-level displays when each of the five function category buttons are pressed;

FIGS. 8(a) through 8(h) and FIGS. 9(a) through 9(c) illustrate the resulting displays for each of the exemplary functions included the “sound” category;

FIGS. 10(a) through 10(g) illustrate the displays corresponding to each of the functions of the FM receiver included in the “play” category;

FIGS. 11(a) through 11(e) illustrate the displays for the exemplary functions of the AM receiver included in the “play” category;

FIGS. 12(a) and 12(b) illustrate the displays for the exemplary functions of the weather band (WX) included in the “play” category;

FIGS. 13(a) through 13(d) illustrate the displays for each of the exemplary CD functions included in the “play” category;

FIGS. 14(a) through 14(g) illustrate the displays for the exemplary functions of the “climate” category;

FIGS. 15(a) through 15(d) illustrate the displays for the exemplary functions associated with the “OnStar®” category; and

FIGS. 16(a) through 16(h) illustrate the displays for the exemplary functions associated with the “Prefs” category.

### DETAILED DESCRIPTION

Disclosed herein is a simplified, reconfigurable interface for vehicle secondary (i.e., non-driving) controls. The manual controls included within the interface may also be used in conjunction with voice command inputs, thereby providing both options to a driver. When mounted in the center stack or console, the reconfigurable controls provide access to both driver and passenger. A similar set of controls may also be mounted on the steering wheel of the vehicle to provide full control functionality with hands-on-the-wheel. Furthermore, additional sets of controls may also be provided for rear-seat passengers to control certain secondary features such as entertainment and climate control (HVAC) systems.

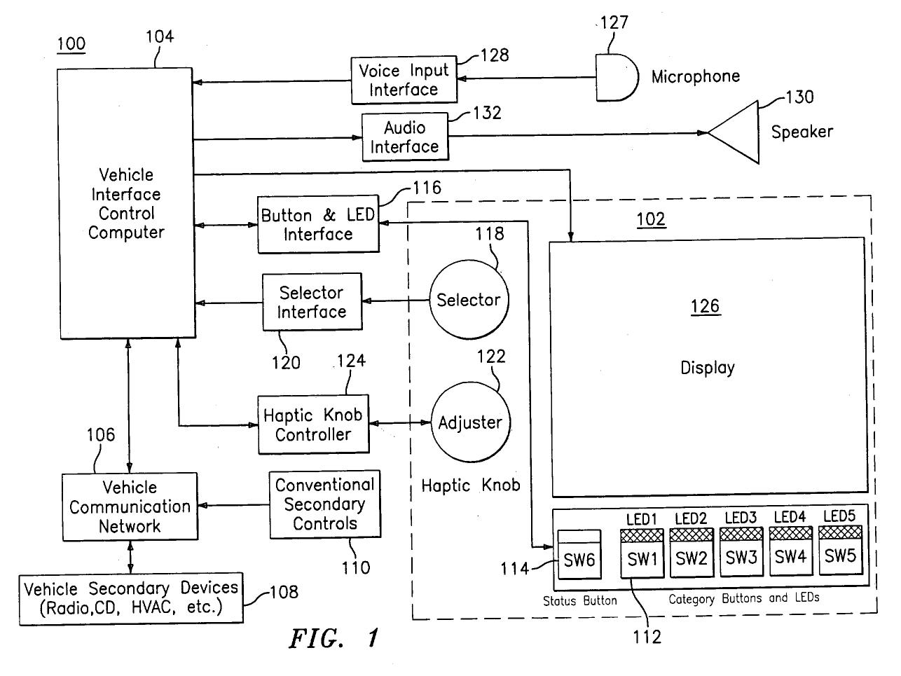

Referring initially to FIG. 1, there is illustrated block diagram of a vehicular secondary control interface system 100, in accordance with an embodiment of the invention. The interface system 100 includes a control panel 102, a vehicle interface control computer 104, a vehicle communication network 106 and various vehicle secondary devices (e.g., radio, CD player, climate control system, etc.) indicated generally by block 108. The interface control computer processes input signals from the control panel 102 and sends control commands to the secondary devices 108 through the communication network 106. It will be appreciated that although many of the secondary control functions are intended to be controlled through control panel 102, some “conventional” secondary control devices (i.e., individual function switches) may still be included in a vehicle. Thus, the system provides for a conventional secondary control inputs, as shown in block 110.

The control panel 102 features a plurality of category buttons 112, individually designated SW1 through SW5, each of which include an LED (designated LED1 through LED5). As will be described in greater detail hereinafter, the category buttons are used to select a general category of control functions (e.g., sound system functions, climate control functions) that are each associated with a number of specific secondary control functions to be controlled. A status button 114 (designated SW6 in FIG. 1) is used to display vehicle status information. A button/LED interface 116 passes input signals from the category buttons 112 and the status button 114 to the interface control computer 104.

Control panel 102 additionally includes a selector knob 118 for selecting a desired secondary function to be controlled, the desired secondary function being within the specific category as selected by pressing one of the category buttons 112. In a preferred embodiment, the selector knob 118 is coupled with a rotary type switch, with fixed detents and without stops. However, other types of switches are also contemplated, and the selector knob 118 may also be provided with haptic feedback. As shown in FIG. 1, however, the selector knob 118 is directly coupled with a selector interface 120 that passes the knob position information to the interface control computer 104.

Once a desired secondary function from a particular category is selected, the parameters of that function (e.g., volume level of the sound system) may be adjusted to the user's preference through adjuster knob 122. The adjuster knob 122 is a haptic knob, in that it provides haptic or tactile feed back to a user. Such haptic devices are well known to those skilled in the art. A haptic knob controller 124 is in communication with both the interface control computer 104 and the adjuster knob 122. Depending upon the particular secondary function to be adjusted, the controller 124 will cause the adjuster knob 122 to provide different haptic properties to the user. For example, if fan speed is the desired secondary function to be controlled, then the adjuster knob 122 may be programmed to include 5 large detents representing 5 discrete fan speeds, a distinct off position, and stops at both ends. In contrast, if the desired secondary function is radio tuning, then the adjuster knob 122 may be programmed to have many small detents and no stops. A suitable example of the adjuster knob 122 is the programmable rotating actuator manufactured by Mannesmann VDO.

The control panel 102 further includes a display area 126 for displaying, among other features, the available secondary control functions and the adjustable parameters of those functions. Thereby, the display area provides visual feedback to the user during the selection and adjustment processes. For example, a volume control function could display a thermometric type bar graphic showing the volume level. Other displays could include the numeric value of a selected radio frequency and band, a climate temperature setting, etc. The specific display hardware may be selected from any acceptable type used in the art. One such suitable example is a DigitalView LCD panel with a 6.4 inch diagonal, 640×480 VGA display.

The interface system 100 is optionally provided with an audio input interface for voice control capability. Specifically, the interface control computer 104 is capable of producing the same control adjustments executed through manual input by receiving voice command events. Accordingly, an audio input device such as a microphone 127 is used to detect a voice command and send it to the interface control computer 104 through a voice input interface 128. As a result, a driver may choose the manner (manual or voice) deemed to be the more convenient means of executing a particular command at a particular time. For example, in some circumstances, it may be more convenient to select Audio/Volume by voice command and then subsequently adjust the volume level manually with the adjuster knob 122. In other situations, such as when the driver is hoarse or involved in a conversation, manual control of both selection and adjustment may be preferred.

A speaker 130 and audio output interface 132 are also optionally included to provide an audio output indication of the category/secondary function selected by the user. In this manner, the driver may, for example, cycle through a group of secondary functions with the selector knob 118 without having to look at the display 126. The audio output for each secondary function is delayed until the movement of the selector knob 118 is stopped for a specified period of time. In other words, if the user is rapidly cycling through a group of secondary functions, there will not be a corresponding rapid output of multiple audio sounds that might be irritating to the occupants of the vehicle. Instead, the audio output of a secondary function will occur only after the specified delay period. In addition, any audio output will be interrupted if either a new secondary function or a new function category is selected during the audio output. The speaker 130 may be one or more speakers from the vehicle's sound system, or it may be provided as a separate component altogether. The audio indication may be implemented through a voice synthesizer, or from a series of stored audio clips.

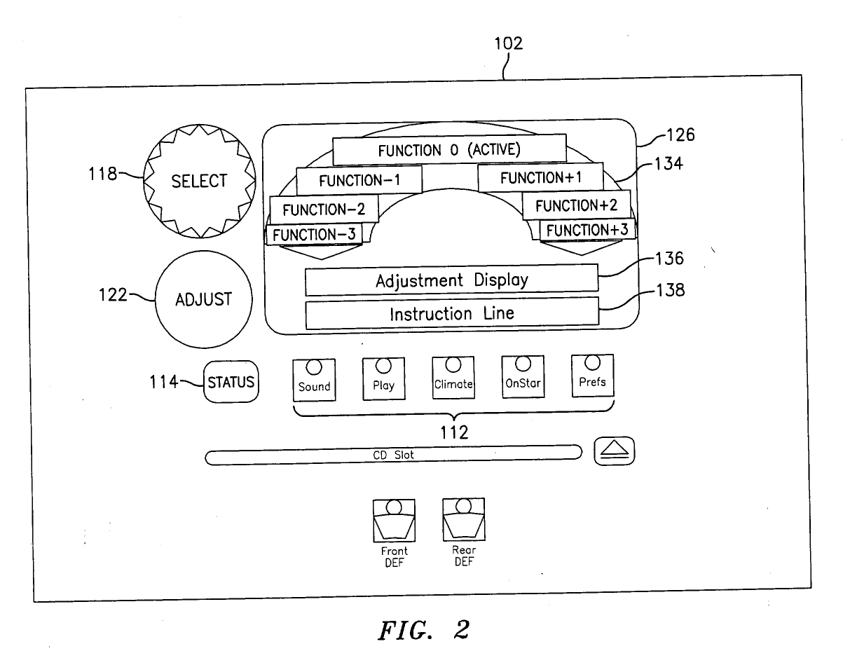

Referring now to FIG. 2, there is shown a schematic diagram of an exemplary layout of the control panel 102 and associated display 126. It should be appreciated, however, that other configurations/layouts for the control panel 102 are also possible. In the example depicted, the display area 126 has three main regions:

(1) a function display region 134 in which available secondary functions of a selected category are displayed (with the “active” function being highlighted in a window); (2) an adjustment display region 136 in which the function parameter(s) to be adjusted are displayed; and (3) an information line area 138 in which a brief instruction may be displayed, which is illustrative of how to implement a particular adjustment of the selected function.

As will be illustrated by way of example hereinafter, the function display region 134 has the capability of displaying up to seven (7) individual functions within a category at any given time. The selected or “active” function is displayed in a window at the top center of the function display region 134, which is denoted by Function 0 in FIG. 2. Up to six (6) non-selected functions are displayed on either side of the active window, and are each labeled in accordance with its relative position with respect to the active window. Thus, the displayed functions to the left of the active window are denoted by Function −1, −2 and −3, while the displayed functions to the right of the active window are denoted by Function +1, +2 and +3. If for example, the desired function was displayed in the position “Function −2”, then in order to select that function for adjustment, the select knob 118 would be rotated clockwise by two positions.

Accordingly, it will be seen that as the select knob 118 is rotated clockwise, then the displayed functions will be shifted clockwise through the function display region 134. Conversely, a counterclockwise rotation of the select knob 118 causes the displayed functions to be shifted counterclockwise through the function display region 134. If a category includes more than seven functions associated therewith, then not all functions will be displayed at once. In this case, if the select knob 118 is rotated clockwise, the function previously displayed at “Function +3” will disappear from the display and a previously undisplayed function will appear at “Function −3”. When there are more functions than can be displayed at once, the function display region will also preferably include an indication that there are additional undisplayed functions. This indication may be in the form of an ellipsis mark ( . . . ) underneath “Function −3” and “Function +3”.

Alternatively, the interface system could be configured such that a counterclockwise rotation of the select knob 118 causes the displayed functions to be shifted clockwise through the function display region 134, and vice versa. It is contemplated that such an arrangement could be more compatible with a user's instinct by turning the knob in the direction that the desired function is located with respect to the function display region 134.

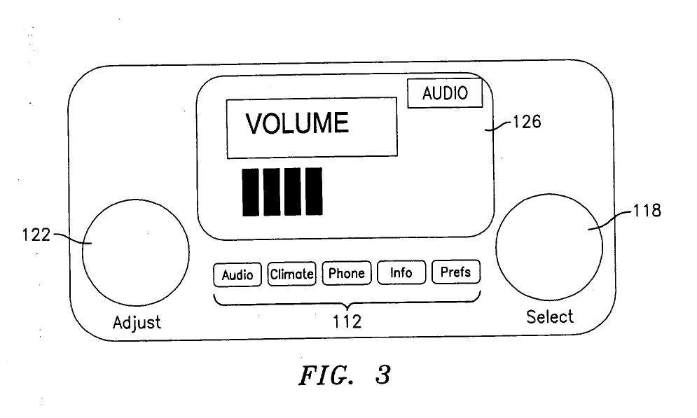

The location of the select knob 118 and the adjust knob 122, as well as the category buttons 112 and the status button 114 provides for a significantly simplified arrangement as compared with conventional vehicle control panels, with the information display area 126 located adjacent the two select and adjust knobs 118, 122 and the category buttons arranged in a row below the display area 126. Again, however, other arrangements are also possible. For example, FIG. 3 illustrates an interface configured to resemble a 1950's style pushbutton radio in which the select knob 118 is located on the right of the display, the adjust knob 122 is located on the left side of the display, and the category buttons 112 are positioned therebetween.

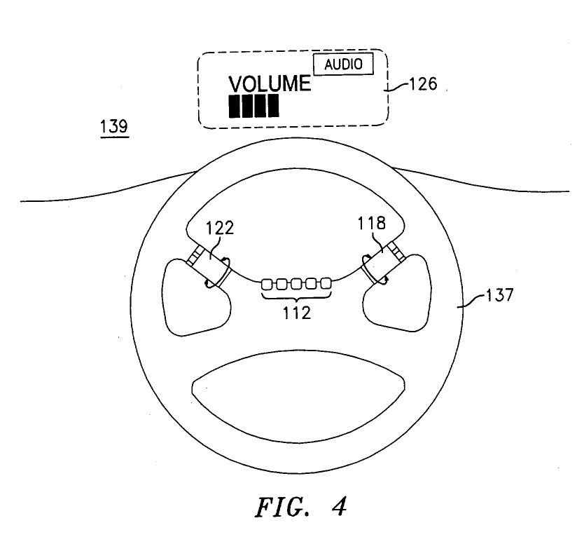

Still another possible interface configuration is shown in FIG. 4, in which the select knob 118, the adjust knob 122 and the category buttons 112 are located on the steering wheel 134 of the vehicle. The display portion 126 appears as a Head Up Display (HUD) on the windshield 136 of the vehicle, thereby allowing driver to maintain eye contact with the road. Furthermore, the HUD may be used in combination with a dashboard display (such as in FIG. 2 or 3), or in may be used in lieu of the dashboard display.

Although there are five category buttons 112 depicted in the exemplary embodiments of FIGS. 2 through 4, there may be a smaller or larger number of category buttons, depending upon the particular number of secondary features available with the vehicle. Further, the determination of the number and nomenclature of categories, as well as which individual functions are associated therewith, is a matter of design choice. In this example, the five main categories include: (1) “Sound”, which controls the sound attributes of the vehicle's audio system (e.g., volume, tone, fade, balance, etc.); (2) “Play”, which controls the active devices of the audio system (e.g., FM radio, AM radio, Weather radio, CD player, etc.), as well as the ability to change the audio source therebetween; (3) “Climate”, which controls the heating, ventilation and air conditioning system; (4) “OnStar®”, which controls access to such specialized features as personal phonebook, email, voicemail, virtual advisor functions, etc.; and (5) “Prefs” which controls miscellaneous driver preference settings such as set clock, driver info, etc.

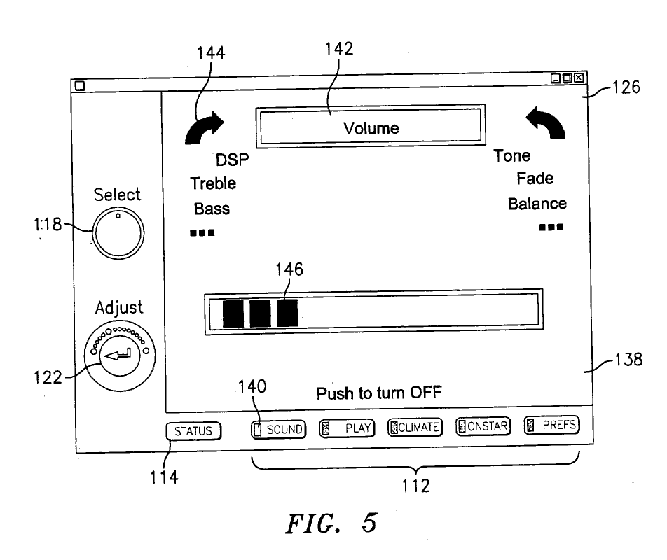

FIG. 5 illustrates the control panel 102 after the “sound” category button has been pushed, indicated by the illuminated LED 140. As can be seen, the “Volume” function is positioned in the active window 142 and is therefore the active function. Accordingly, turning the adjust knob 122 now directly controls the volume of the sound system, as would be the case for a dedicated volume control. The arrows 144 in the upper left and right corners of the function display region 134 indicate the direction to turn the select knob 118 in order to shift the functions into the active window 142. Again, the ellipsis marks ( . . . ) indicate that there are additional sound related functions not presently visible in the list of seven shown. As shown in the adjustment display region 136, a thermometric bar 146 is used to graphically display the volume level of the sound system. Lastly, FIG. 5 also illustrates additional instructions (“Push to turn OFF”) shown in the information line area 138 at the bottom of the display 126.

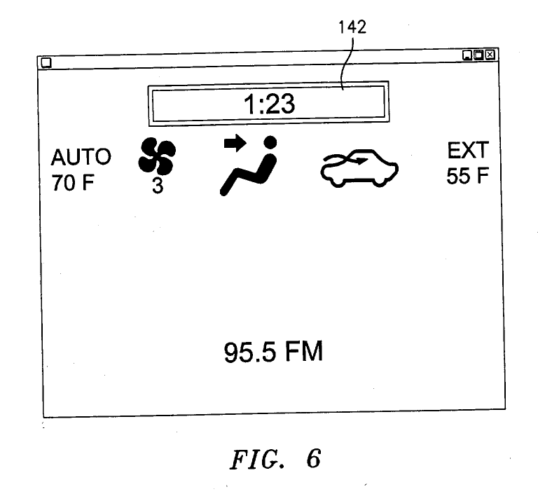

FIG. 6 illustrates an exemplary status screen that is accessed after a certain period of time after the select and adjust functions have been activated, or by directly pressing the status button 114. In this example, the status screen includes the time of day shown in the active window 142, the climate control status as indicated by the five icons underneath the active window, and the audio status at the bottom. As will be appreciated, however, additional or different information may be included in the status display.

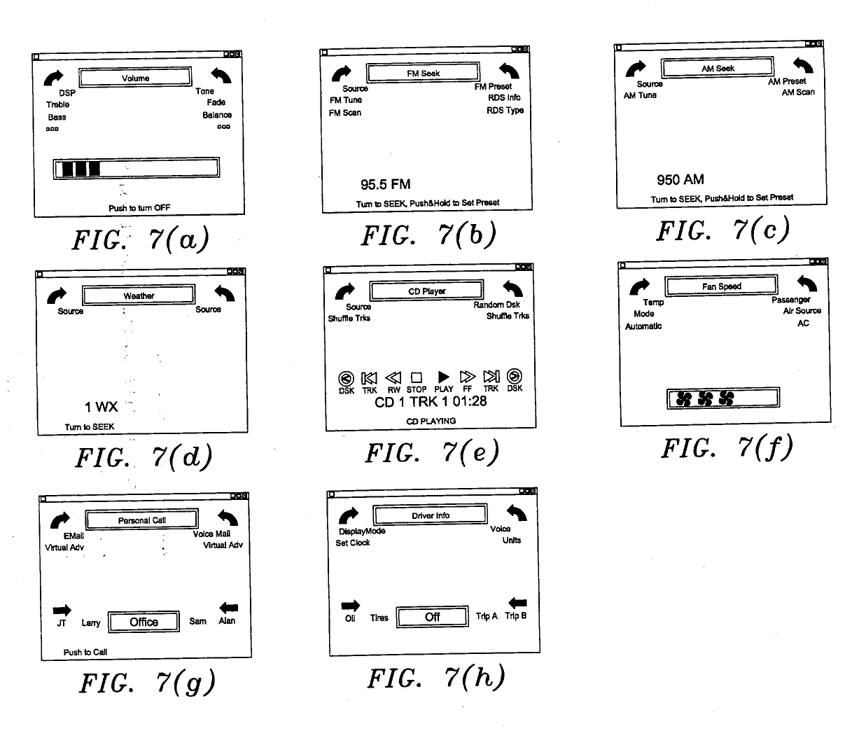

FIGS. 7(a) through 7(h) illustrate the top-level displays when each of the five function category buttons 112 are pressed. FIG. 7(a) shows the display when the “sound” category button is activated, as will be recalled from the description of FIG. 3. FIGS. 7(b) through 7(e) illustrate four possible displays when the “play” category button is activated, depending upon the current source of audio activated in the vehicle. More specifically, FIG. 7(b) shows the display screen for the FM receiver, FIG. 7(c) shows the display screen for the AM receiver, FIG. 7(d) shows the display screen for the weather band, and FIG. 7(e) shows the display screen for the CD player. In addition, FIG. 7(f) illustrates the display when the “climate” button is activated, FIG. 7(g) illustrates the display when the “OnStar®” button is activated, and FIG. 7(h) illustrates the display when the “prefs” (driver information) button is activated.

It will be noted that in the “play” category, only the functions for the active audio source are available in addition to the “source” function for selection of a different source. If there is no CD present in the CD player, then “CD” will not appear in the list of available sources. Furthermore, the addition of a new audio source such as satellite radio (XM), for example, would add still another entry in the source list and would be associated with a corresponding set of appropriate functions. However, no new physical controls would be needed.

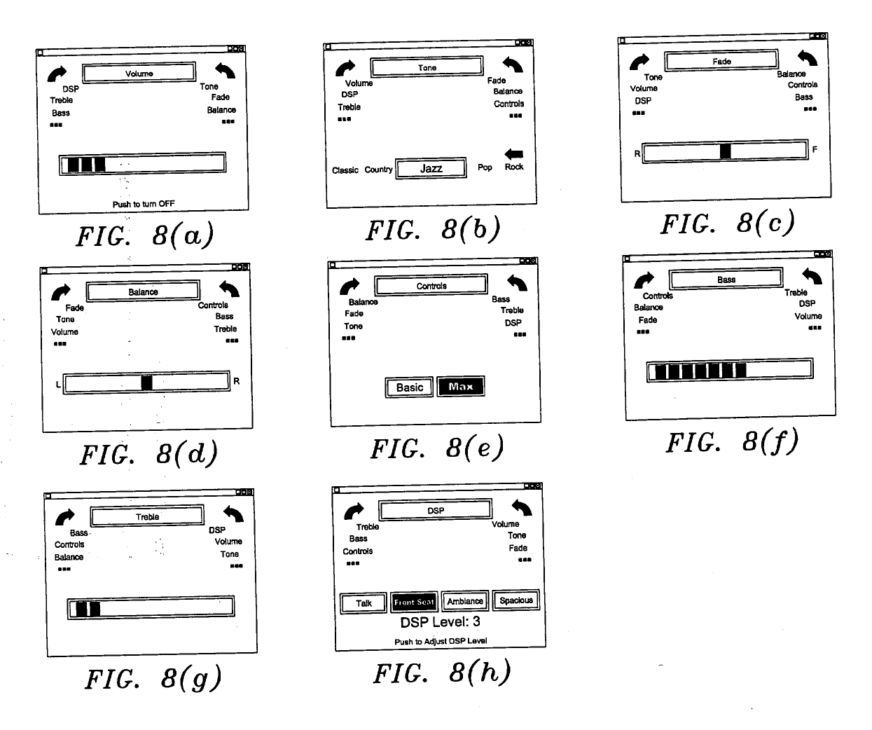

FIGS. 8(a) through 8(h) illustrate the resulting displays for each of the exemplary functions included in the “sound” category. As can be seen, whenever a new active sound function is selected, the adjustment display region 136 and the information line area 138 change accordingly. Also, depending upon the parameters of the function to be adjusted, a new haptic effect is initiated for the adjust knob 122. The different functions selected in the “sound” category result in different displays and haptic features. For example, the fade and balance functions are adjusted and displayed by a sliding bar.

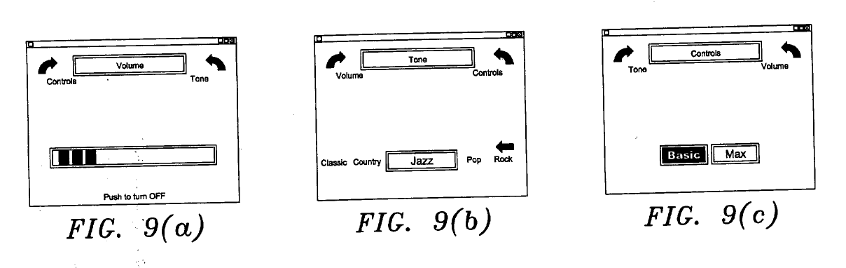

Another possible feature allows a user to adjust the number of functions available in a given category. This is exemplified by the “controls” function shown in FIG. 8(e). The “controls” function allows for a choice between a basic set of sound functions and a “maximum” (i.e., expanded) set of sound functions. When set to “Max”, the “controls” function allows all of the sound functions to be accessed with the select knob 118. When set to “Basic”, the “controls” function reduces the total available sound functions to just three: “volume”, “tone” and “controls”. This feature is further illustrated in the displays of FIGS. 9(a) through 9(c).

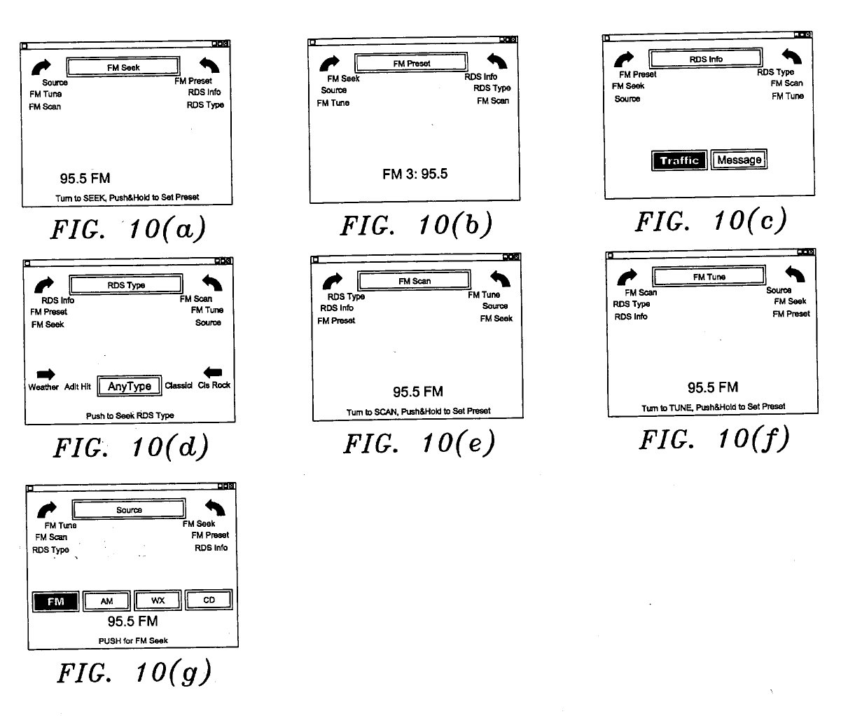

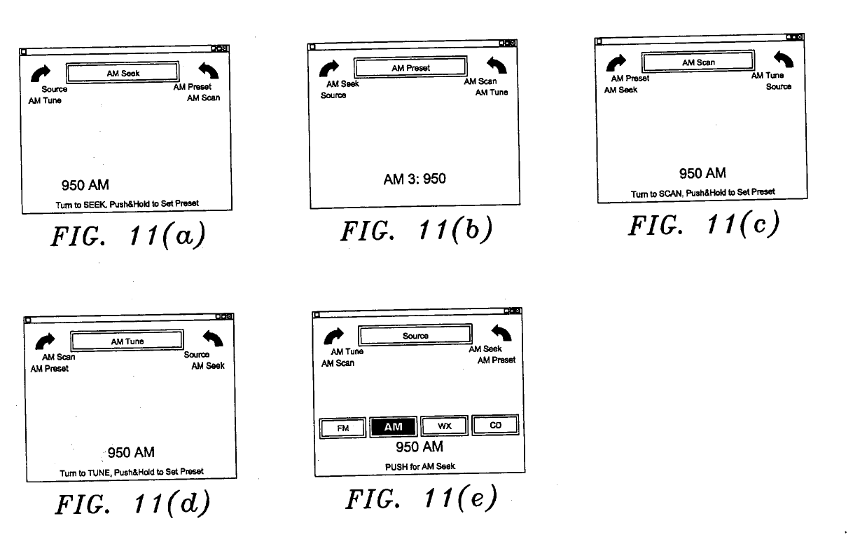

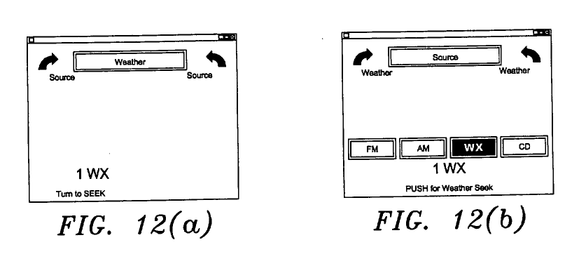

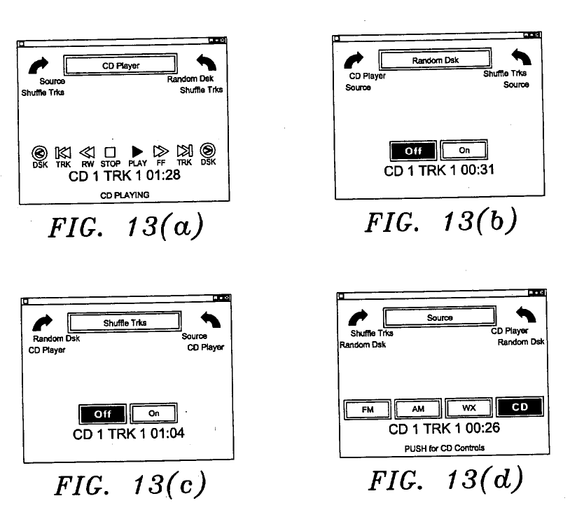

The individual functions of the “play” category will vary, depending upon the active audio source. FIGS. 10(a) through 10(g) illustrate the displays corresponding to each of the functions of the FM receiver. FIGS. 11(a) through 11(e) illustrate the displays for the functions of the AM receiver, while FIGS. 12(a) and 12(b) are the displays for the weather band (WX). In FIGS. 13(a) through 13(d), the displays for each of the CD functions are illustrated. It will be noted that the “source” function is included with each audio source, thereby providing the capability of switching audio sources via the adjust knob 122. Alternatively, multiple presses of the “play” category button can cycle through the source options.

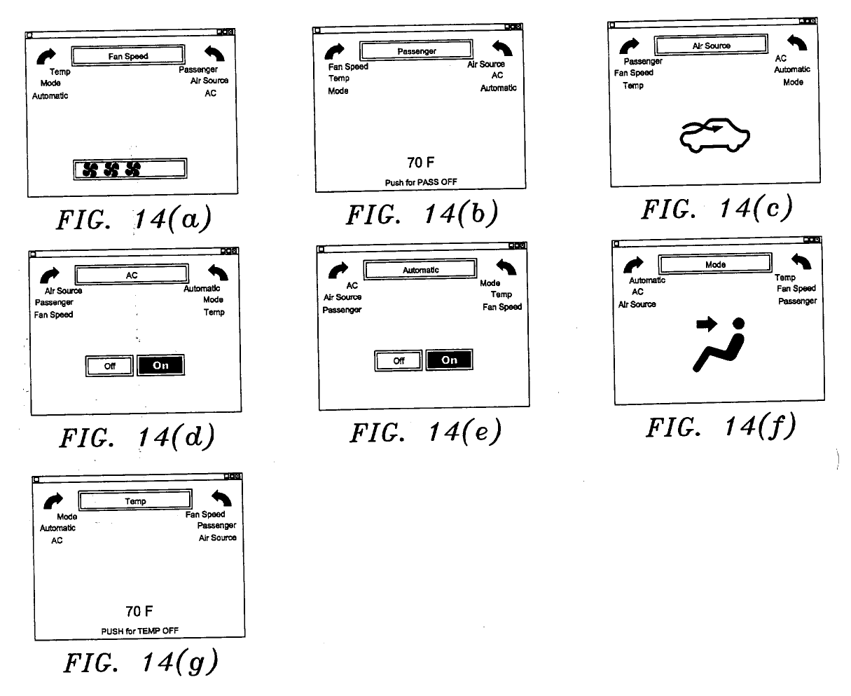

Referring now to FIGS. 14(a) through 14(g), exemplary displays for the functions of the “climate” category are illustrated. In particular, the “Air Source” function provides for switching between recirculation and outside air when the adjust knob 122 is turned. The “Mode” function provides for air path options between “Floor”, “High” (shown in FIG. 14(f)), “Bilevel”, “Defog”, and “Defrost”, selected by turning the adjust knob 122, and each with a corresponding visual display.

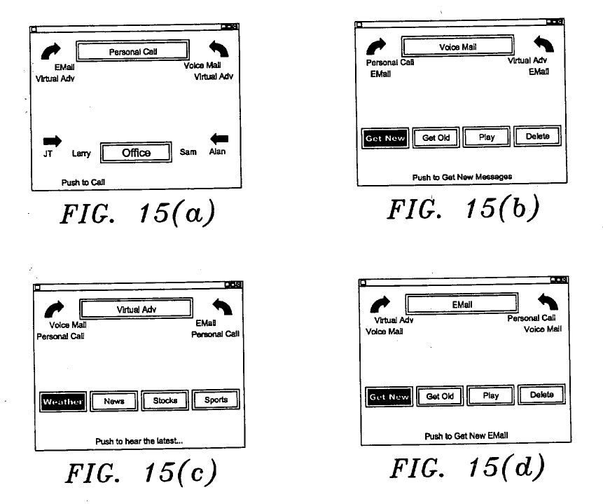

FIGS. 15(a) through 15(d) illustrate the displays for the functions associated with the “OnStar®” category. In this embodiment, the individual entries in the “Personal Call” function are made through the OnStar® website as is the case with the current voice activated system. Access to voice mail and email may be provided in an interface resembling that of a simple home telephone answering machine.

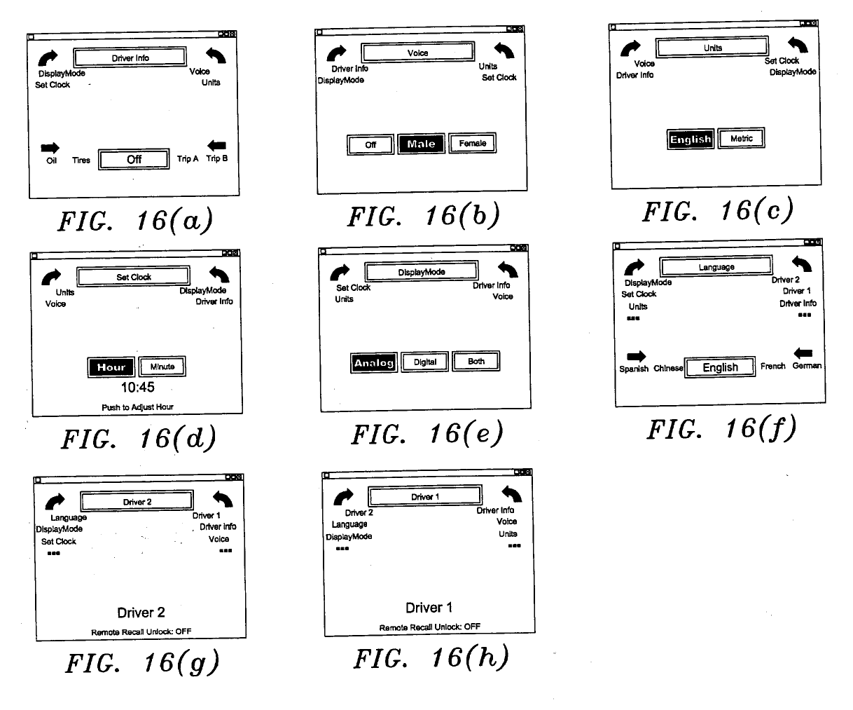

Finally, FIGS. 16(a) through 16(h) illustrate the displays for the functions associated with the “Prefs” category. For instance, the “Driver Info” function in FIG. 16(a) allows the user to select an information item (e.g., Trip A, Trip B, and Oil Life) to be displayed and/or reset. Certain “Prefs” functions are available only when the vehicle is in park, such as changing the language (FIG. 16(f)), and setting the preferences for “Driver 1” and “Driver 2” (FIGS. 16(g) and 16(h)). The Driver 1 and 2 preferences provide the ability to turn on or off several different features such as “Horn at Lock” or “Mirror to Curb in Reverse”. Turning the adjust knob 122 scrolls through the list of such features, while pressing the adjust knob 122 turns the displayed feature either on or off.

It will thus be appreciated that the above described secondary control interface system has the ability to interface with an arbitrary number of secondary vehicle functions through a relatively small fixed number of buttons and knobs. With this approach, individual functions may be added or removed without adding more physical controls to the vehicle. The programmable haptic adjust knob provides the familiar feel of several individual specialized controls, while voice output enables a driver to operate many of the controls without actually looking down at the display.

Furthermore, the control hardware is independent of the options content of the vehicle and therefore can be the same for every vehicle. Rear-seat controls may also be a duplicate of the front seat controls. While the function selection lists may vary from vehicle to vehicle (according to the installed options, and could further vary from front to rear locations), the software may remain identical. However, the list of functions could be updated if new options were added to a vehicle in the after market. In addition, the categories and function names could be structured with different terminologies by brand, or even be displayed in a different language by setting an appropriate driver preference function.

The interface system is reconfigurable in at least three ways. First, a driver can choose to have certain functions present or not (e.g., the number of audio controls). The interface can further restrict the available functions in a given context (e.g., not displaying AM or CD functions when playing FM, or only making certain functions available when appropriate, such as when the vehicle is in park). Still another option is to make the availability of functions dependent upon driver workload. In such a case, certain functions could actually disappear (as opposed to just being disabled), thereby eliminating the potential confusion and frustration of pressing an inoperative button.

While the invention has been described with reference to a preferred embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A vehicular secondary control interface, comprising:
a plurality of category input devices for selecting a function category, each of said function categories having one or more selectable secondary functions associated therewith;
a display area for displaying said one or more selectable secondary functions associated with a selected function category, said display area highlighting an active one of said one or more selectable secondary functions, and said display area further displaying parameter information regarding said active one of said one or more selectable secondary functions;
a selection input device for adjustably selecting said one or more selectable secondary functions associated with a selected function category; and
an adjustment input device for controlling said active one of said one or more selectable secondary functions associated with said selected function category.

2. The control interface of claim 1, wherein said adjustment input device is configured with programmable haptic feedback.

3. The control interface of claim 1, wherein said display area further displays status information after a determined period of time following activation of any of said category input devices, said selection input device, and said adjustment input device.

4. The control interface of claim 3, further comprising a status input device, said status input device, when activated, causing said display area to immediately display said status information.

5. The control interface of claim 1, wherein said display area further comprises an information line area for displaying instructions associated with said active one of said one or more selectable secondary functions.

6. The control interface of claim 1, wherein said function categories and said one or more selectable secondary functions associated therewith are further selectable by voice command received by an audio input device.

7. The control interface of claim 1, further comprising an audio output device for generating an audio output representative of a selected function category.

8. The control interface of claim 7, wherein said audio output device further generates an audio output representative of a selected secondary function.

9. The control interface of claim 8, wherein said audio output representative of a selected secondary function is delayed for a specified time period following a user input to said selection input device.

10. The control interface of claim 8, wherein:
said audio output representative of a selected function category is interrupted whenever another of said plurality of category input devices is activated; and
said audio output representative of a selected secondary function is interrupted whenever said selection input device is used to select another secondary function.

11. The control interface of claim 1, wherein:
said active one of said one or more selectable secondary functions is displayed in an active window defined in said display area;
said display area is further capable of displaying up to N of said one or more selectable secondary functions, including said active one;
wherein any other of said one or more selectable secondary functions is selected by engaging said selection input device until said any other of said one or more selectable secondary functions appears in said active window.

12. The control interface of claim 11, wherein:
said one or more selectable secondary functions are shifted across said display area in a first direction by engaging said selection input device in said first direction;
said one or more selectable secondary functions are shifted across said display area in a second direction by engaging said selection input device in said second direction; and
if the total number of said one or more selectable secondary functions for a given function category exceeds N, then said display area provides an indication that at least one of said one or more selectable secondary functions is not presently displayed in said display area.

13. The control interface of claim 11, wherein:
said one or more selectable secondary functions are shifted across said display area in a first direction by engaging said selection input device in a second direction opposite to said first direction;
said one or more selectable secondary functions are shifted across said display area in said second direction by engaging said selection input device in said first direction; and
if the total number of said one or more selectable secondary functions for a given function category exceeds N, then said display area provides an indication that at least one of said one or more selectable secondary functions is not presently displayed in said display area.

14. The control interface system of claim 1, wherein each of said plurality of category input devices includes an LED that illuminates when the corresponding category input device is activated.

15. A vehicular secondary control interface system, comprising:
an interface control computer in communication with a plurality of vehicle secondary devices and a vehicle control panel, said vehicle control panel further comprising:
a plurality of category buttons for selecting a function category, each of said function categories having one or more selectable secondary functions associated therewith;
a display area for displaying said one or more selectable secondary functions associated with a selected function category, said display area highlighting an active one of said one or more selectable secondary functions, and said display area further displaying parameter information regarding said active one of said one or more selectable secondary functions;
a select knob for adjustably selecting said one or more selectable secondary functions associated with a selected function category; and
an adjust knob for controlling said active one of said one or more selectable secondary functions associated with said selected function category.

16. The control interface system of claim 15, further comprising a haptic knob controller in communication with said interface control computer, said haptic knob controller thereby providing said adjust knob with programmable haptic feedback.

17. The control interface system of claim 15, wherein said display area further displays status information after a determined period of time following activation of any of said category buttons, said select knob, and said adjust knob.

18. The control interface system of claim 17, further comprising a status button, said status button, when activated, causing said display area to immediately display said status information.

19. The control interface system of claim 15, wherein said display area further comprises an information line area for displaying instructions associated with said active one of said one or more selectable secondary functions.

20. The control interface system of claim 15, wherein said function categories and said one or more selectable secondary functions associated therewith are further selectable by voice command received by an audio input device in communication with said interface control computer.

21. The control interface system of claim 15, further comprising an audio output device in communication with said interface control computer, said audio output device for generating an audio output representative of a selected function category.

22. The control interface system of claim 21, wherein said audio output device further generates an audio output representative of a selected secondary function.

23. The control interface system of claim 22, wherein said audio output representative of a selected secondary function is delayed for a specified time period following a user input to said select knob.

24. The control interface system of claim 22, wherein:
said audio output representative of a selected function category is interrupted whenever another of said plurality of category buttons is activated; and
said audio output representative of a selected secondary function is interrupted whenever said select knob is used to select another secondary function.

25. The control interface system of claim 15, wherein:
said active one of said one or more selectable secondary functions is displayed in an active window defined in said display area;
said display area is further capable of displaying up to N of said one or more selectable secondary functions, including said active one;
wherein any other of said one or more selectable secondary functions is selected by engaging said selection input device until said any other of said one or more selectable secondary functions appears in said active window.

26. The control interface system of claim 25, wherein:
said one or more selectable secondary functions are shifted across said display area in a first direction by engaging said select knob in said first direction;
said one or more selectable secondary functions are shifted across said display area in a second direction by engaging said select knob in said second direction; and
if the total number of said one or more selectable secondary functions for a given function category exceeds N, then said display area provides an indication that at least one of said one or more selectable secondary functions is not presently displayed in said display area.

27. The control interface system of claim 25, wherein:
said one or more selectable secondary functions are shifted across said display area in a first direction by engaging said select knob in a second direction opposite to said first direction;
said one or more selectable secondary functions are shifted across said display area in said second direction by engaging said select knob in said first direction; and
if the total number of said one or more selectable secondary functions for a given function category exceeds N, then said display area provides an indication that at least one of said one or more selectable secondary functions is not presently displayed in said display area.

28. The control interface system of claim 15, wherein each of said plurality of category buttons includes an LED that illuminates when the corresponding category button is activated.
